(19) United States
(12) Patent Application Publication
(10) Pub. No.: US 2025/0273885 A1
(43) Pub. Date: Aug. 28, 2025

(54) FLAT FLEXIBLE CABLE WITH EMBEDDED GROUND PLANE

(71) Applicant: INTERNATIONAL BUSINESS MACHINES CORPORATION, ARMONK, NY (US)

(72) Inventors: Sassan K. Shahidi, San Jose, CA (US); Brandon Purcell, San Jose, CA (US)

(21) Appl. No.: 18/590,230

(22) Filed: Feb. 28, 2024

(51) Int. Cl. H01R 12/59; H01R 12/77; H01R 12/78

(52) U.S. Cl. CPC H01R 12/592; H01R 12/775; H01R 12/78

(57) ABSTRACT

A flat flexible cable including a first conductive layer with a plurality of traces, a second conductive layer with a second plurality of traces, a first non-conductive layer disposed between the first conductive layer and the second conductive layer, and a second non-conductive layer disposed between the second conductive layer and a conductive ground layer, where the first conductive layer, the second conductive layer, and the conductive ground layer are electrically connected.

### BACKGROUND

The present disclosure relates generally to the field of electronics, and more particularly, to flat flexible cable designs.

Flat flexible cables (FFC's) are electrical cables that are substantially flat and flexible (i.e., can be easily bent without cracking or breaking). FFC's typically incorporate etched or printed circuits that are built onto a flexible material. They are used in a variety of electronic devices, including laptops, cell phones, and storage devices.

### SUMMARY

Aspects of the present disclosure relate to designs of and methods for forming flat flexible cables.

Aspects of the present disclosure are directed toward a flat flexible cable including a first conductive layer with a plurality of traces, a second conductive layer with a plurality of traces, a first non-conductive layer disposed between the first conductive layer and the second conductive layer, and a second non-conductive layer disposed between the second conductive layer and a conductive ground layer, where the first conductive layer, second conductive layer, and conductive ground layer are electrically connected.

Additional aspects of the present disclosure are directed toward a method for forming a flat flexible cable. The method can comprise bonding a first conductive layer having plurality of traces, a second conductive layer having a plurality of traces, a first non-conductive layer, a second non-conductive layer, and a conductive ground layer together, wherein the first non-conductive layer is disposed between the first conductive layer and the second conductive layer and the second non-conductive layer is disposed between the second conductive layer and the conductive ground layer. The method can further comprise creating an electrical connection between the first conductive layer, second conductive layer, and the conductive ground layer.

Additional aspects of the present disclosure are directed toward a flat flexible cable including a first conductive layer with a plurality of traces, a second conductive layer with a plurality of traces, a first non-conductive layer disposed between the first conductive layer and the second conductive layer, and a conductive adhesive layer disposed between a second non-conductive layer and a conductive ground layer, wherein the second non-conductive layer is disposed between the second conductive layer and the conductive adhesive layer, wherein the first conductive layer, second conductive layer, conductive adhesive layer, and conductive ground layer are electrically connected.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a perspective view illustrating a conductive layer disposed on a flexible substrate, in accordance with embodiments of the present disclosure.

FIG. 2 is a perspective view illustrating conductive layer traces formed on a flexible substrate, in accordance with embodiments of the present disclosure.

FIG. 3 is a perspective view illustrating adherence of a non-conductive layer onto the conductive layer traces and flexible substrate, in accordance with embodiments of the present disclosure.

FIG. 4 is a cross-sectional view illustrating a multi-layered structure of a flat flexible cable including a ground layer, in accordance with embodiments of the present disclosure.

FIG. 5 is a cross-sectional view illustrating another multi-layered structure of a flat flexible cable including a ground layer, in accordance with embodiments of the present disclosure.

FIG. 6 is a flow-chart illustrating a method for forming a flexible flat cable with an embedded ground layer, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of electronics, and more particularly, to a flat flexible cable design. While the present disclosure is not necessarily limited to such applications, various aspects of the disclosure may be appreciated through a discussion of various examples using this context.

As discussed above, FFC's are electrical cables that are substantially flat and flexible. FFC's may incorporate etched or printed circuits that are built onto a flexible material. They are used in a variety of electronic devices, including laptops, cell phones, and storage devices. FFC's may be comprised of multiple layers of different materials and bonding adhesives that are sandwiched together under heat and pressure. Depending on the design specification required, traces for carrying electrical signals and spaces between traces are becoming narrower. This can enable the inclusion of more traces for carrying electrical signals within an FFC, thereby improving the amount of data that can be transmitted within the same size of cable.

However, as the number of traces increases and/or the spacing between traces decreases, crosstalk issues arise where signals from one trace affect the neighboring traces. Additionally, electro-magnetic interference (EMI) becomes an issue that affects the overall signal transmission integrity of the FFC. EMI has various negative effects, including distortion of transmitted data and even complete loss of data. Thus, FFC designs that increase the number of traces and/or decrease the spacing between traces while also reducing crosstalk and EMI between traces are desirable.

Aspects of the present disclosure relate to an improved FFC design including a multi-layered structure having an embedded ground plane. The FFC includes a first conductive layer with a plurality of traces, a second conductive layer with a plurality of traces, a first non-conductive layer disposed between the first conductive layer and the second conductive layer, and a second non-conductive layer disposed between the second conductive layer and a conductive ground layer, where the first conductive layer, second conductive layer, and third conductive layer are electrically connected.

Aspects of the present disclosure improve upon existing FFC designs. By incorporating non-conductive layers between conductive layers, crosstalk and/or EMI between conductive layers can be reduced. For example, polyimide (or other dielectric/insulative materials) can absorb and dissipate signals between neighboring traces and/or conductive layers efficiently, thereby improving electrical performance. Further still, the inclusion of a conductive ground layer acts as an EMI shield to improve overall efficiency of the FFC design. The conductive ground layer can be positioned outside the electrical signal traces to block electromagnetic fields produced during operation. By grounding conductive layers to the conductive ground layer, all conductive layers are electrically grounded to one another and therefore a path is provided for charge to be dissipated, thereby reducing EMI. This can allow FFC designs that incorporate conductive layers with narrower traces, a larger amount of traces, and/or narrower spaces between traces while maintaining acceptable EMI and crosstalk.

Various embodiments of the present disclosure are described herein with reference to the related drawings. Alternative embodiments can be devised without departing from the scope of the present disclosure. It is noted that various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” if the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

For purposes of the description hereinafter, the terms “upper,” “lower,” “right,” “left,” “vertical,” “horizontal,” “top,” “bottom,” and derivatives thereof shall relate to the depicted structure(s) as oriented. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, substantial coplanarity between various materials can include an appropriate manufacturing tolerance of ±8%, ±5%, ±2%, or the like, difference between the coplanar materials.

As used herein, the term “coplanar” refers to two surfaces that lie in a common plane. In other words, two surfaces are coplanar if there exists a geometric plane that contains all the points of both of the surfaces. Accordingly, two surfaces may be referred to as substantially coplanar despite deviations from coplanarity, so long as those deviations do not impact the desired result of the coplanarity.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Additionally, explicit or implicit dimensions (whether absolute or relative to other portions of the drawings) are for example purposes only and are not to be construed as limiting. For example, absolute or relative lengths, widths, heights, thicknesses, angles, arcs, circumferences, and the like, as illustrated in the drawings, are for example purposes alone and should not be construed as limiting.

For the sake of brevity, conventional techniques related to semiconductor device fabrication may or may not be described in detail and/or depicted herein. Moreover, the various tasks and process steps described herein can be incorporated into a more comprehensive procedure or process having additional steps or functionality not described and/or not depicted in detail herein. Various steps in the manufacture of semiconductor devices are well known and so, in the interest of brevity, many conventional steps will only be mentioned briefly herein, will be omitted entirely without providing the well-known process details, and/or will not be depicted.

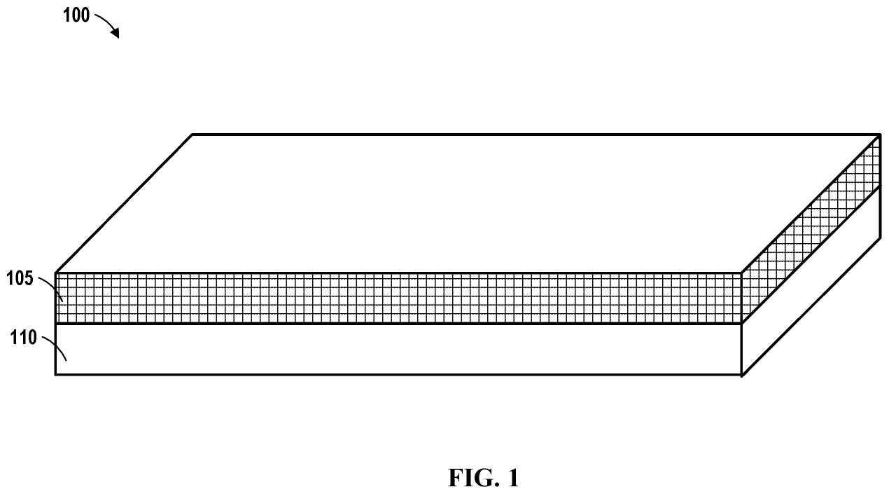

Referring now to FIG. 1, shown is a perspective view of a conductive layer 105 disposed on a flexible substrate 110, thereby forming a flexible conductive base 100, in accordance with embodiments of the present disclosure. In embodiments, the conductive layer 105 can be copper, gold, silver, tungsten, aluminum, ruthenium, rhodium, cobalt, tantalum, titanium, carbon nanowire materials including graphene, and/or any other suitable electrically conductive material or combination of materials. The flexible substrate 110 can be any suitable flexible printed circuit board (PCB) material, such as polyimide, polyester, FR4, polyethylene terephthalate (PET), PTFE (Teflon), and others. The conductive layer 105 can be disposed onto the flexible substrate 110 in any suitable manner. For example, the conductive layer 105 can be disposed onto the flexible substrate 110 using plating, lamination, and deposition, among other techniques. Deposition can include physical vapor deposition (PVD), chemical vapor deposition (CVD), electrochemical deposition (ECD), molecular beam epitaxy (MBE), and atomic layer deposition (ALD), among others. The type of technique used for disposing the conductive layer 105 onto the flexible substrate can depend on the type of material implemented in the conductive layer 105.

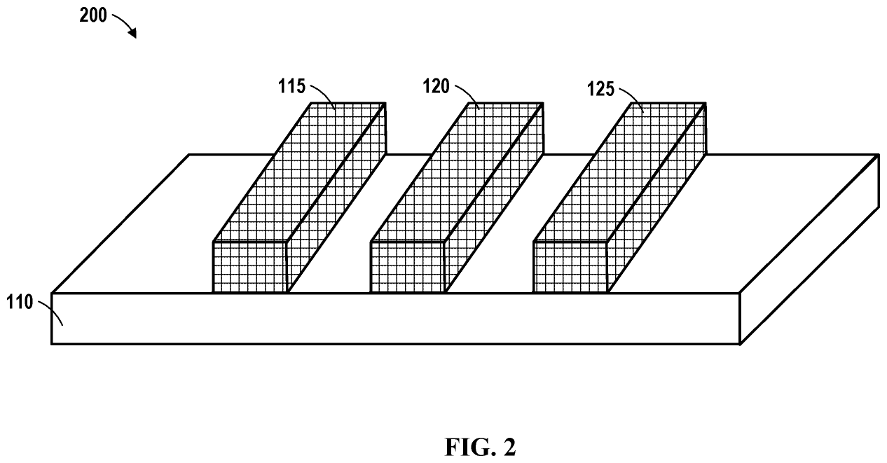

Referring now to FIG. 2, shown is a perspective view of a flexible base with uninsulated conductive traces 200 having a plurality of traces 115, 120, and 125 formed by removing of portions of the conductive layer (e.g., conductive layer 105 of FIG. 1). The traces 115, 120, 125 correspond to the material of the conductive layer 105 of FIG. 1. In embodiments, formation of the traces 115, 120, and 125 can be completed using photolithography techniques. For example, an etch resist layer (not shown) can be applied to the conductive layer 105 using lamination or another process. Thereafter, ultraviolet (UV) light can be selectively applied to the etch resist layer in the areas where traces are desired. Thereafter, the undeveloped areas of the etch resist layer (i.e., that were not exposed to UV light) can be chemically washed off the flexible substrate 110. In embodiments, potassium carbonate, or another suitable solution, can be used to wash off the undeveloped etch resist layer. Thereafter, the portions of the conductive layer 105 that are now exposed (e.g., not covered by the etch resist layer) can be chemically removed. For example, cupric chloride or another etchant (e.g., alkaline-based etchants or ferric chloride-based etchants) can be used to remove portions of the exposed conductive layer 105, thereby forming traces 115, 120, and 125. However, alternative manners for forming the traces 115, 120, and 125 can be implemented without departing from the spirit and scope of the present disclosure, such as directly printing the traces 115, 120, and 125 onto the flexible substrate 110. The traces 115, 120, and 125 of the conductive layer 105 can be used for carrying electrical signals throughout an FFC.

The number of traces, trace pitch, material of traces, and/or dimensions of traces can vary based on design specifications of an FFC the traces will be implemented into. In embodiments, the traces can have a width of approximately 20-100 μm. In embodiments, the trace pitch (e.g., spacing between individual traces) can be approximately 3×-5× of the trace width. In embodiments, conductive traces can be formed with multiple materials. For example, in embodiments, traces can be gold-plated copper.

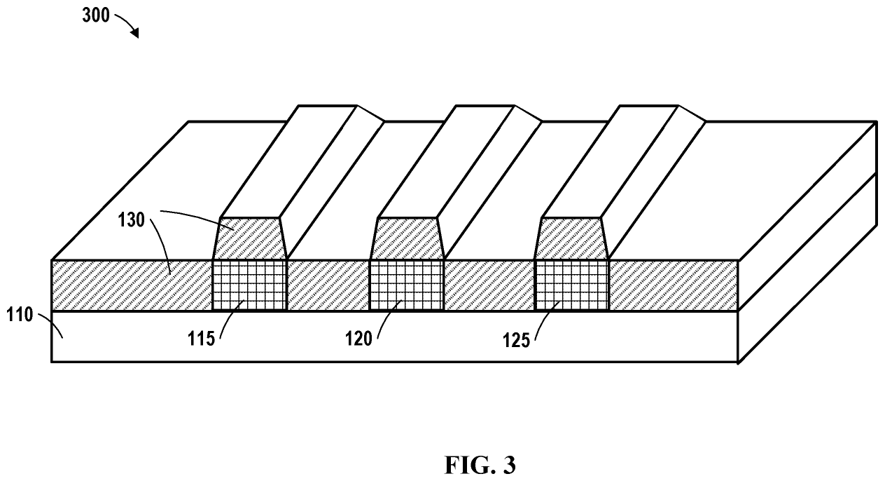

Referring now to FIG. 3, shown is a perspective view of a flexible base with insulated conductive traces 300 including an insulative or dielectric layer, herein referred to as a non-conductive layer 130, disposed on the flexible substrate 110 and traces 115, 120, and 125 of the conductive layers 105. The non-conductive layer 130 can be applied to prevent EMI, crosstalk, electrical shorts, and to protect traces 115, 120, and 125 from contamination. In embodiments, the non-conductive layer 130 can be a polyimide film having a thermal set adhesive on one side of the film. However, different materials can be implemented, including polyester, FR4, polyethylene terephthalate (PET), PTFE (Teflon), and others. The non-conductive layer 130 can be disposed on the flexible substrate 110 and traces 115, 120, and 125 using a lamination process. For example, the non-conductive layer 130 (e.g., polyimide having a thermal set adhesive) can be placed on top of the etched traces 115, 120, and 125 and thereafter subject to heat and pressure, for example, using an autoclave or vacuum press. As an example, the lamination process can expose the applied non-conductive layer 130 to between about 170-250 pounds per square inch (psi) at about 375-425 degrees Fahrenheit for a particular amount of time (e.g., 1 hour). However, any suitable technique for disposing the non-conductive layer 130 onto the flexible substrate 110 and traces 115, 120, and 125 can be implemented.

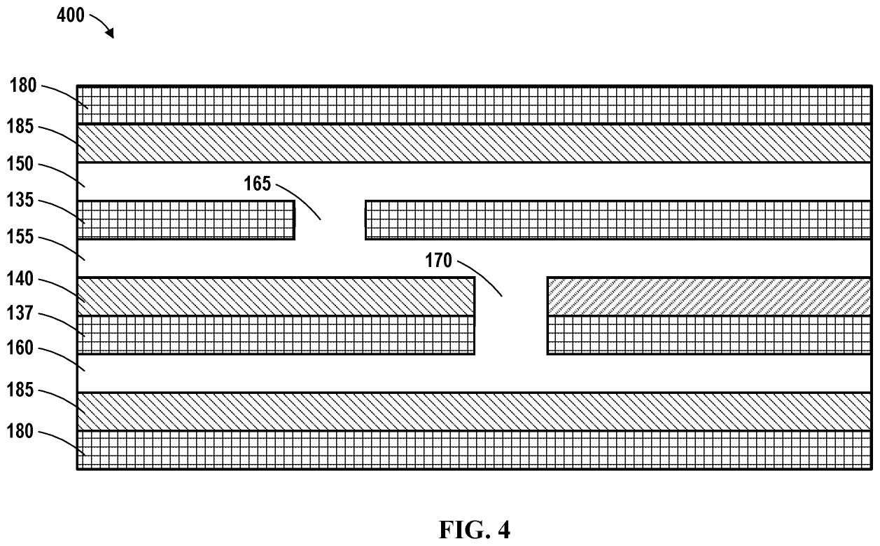

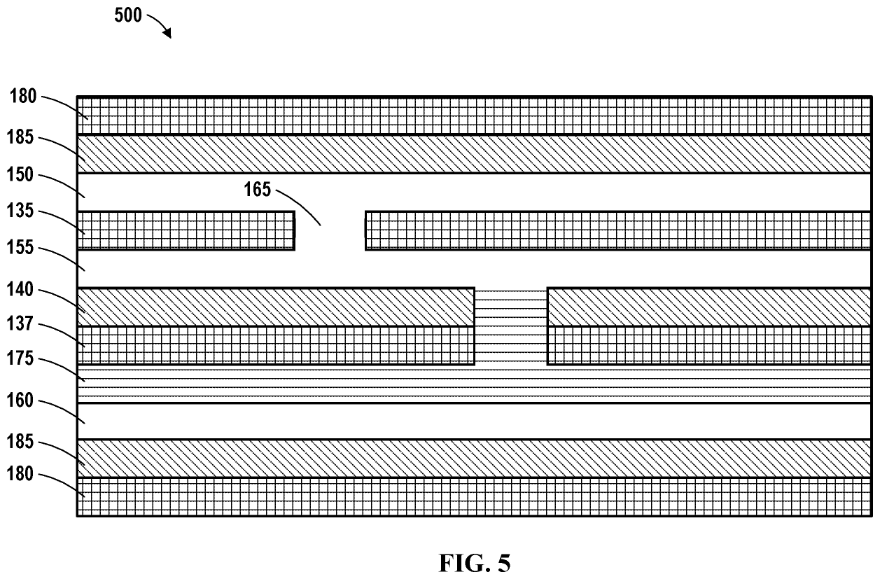

FIGS. 1-3 depict the process for forming the flexible base with insulated conductive traces 300. However, it is noted that additional traces can be included, additional layers can be included without necessarily being shown (e.g., thermal set adhesive layers), different geometries/dimensions can be implemented, and different materials and/or processes can be used without departing from the spirit and scope of the present disclosure. The flexible base with insulated conductive traces 300 can be used/processed to generate the multi-layered structures depicted in FIGS. 4-5.

Referring now to FIG. 4, shown is a cross-sectional view of a multi-layered structure including an embedded ground layer 400 that can be incorporated into an FFC, in accordance with embodiments of the present disclosure. The multi-layered structure including the embedded ground layer 400 includes a first conductive layer 150, a second conductive layer 155, and a conductive ground layer 160. The first conductive layer 150 and second conductive layer 155 can each include a plurality of traces (e.g., traces 115, 120, and 125). The conductive ground layer 160 can be any suitable conductive compound used for grounding the first conductive layer 150 and second conductive layer 155. For example, the conductive ground layer 160 can be copper, gold, silver, tungsten, aluminum, ruthenium, rhodium, cobalt, tantalum, titanium, carbon nanowire materials including graphene, and/or any other suitable electrically conductive material or combination of materials.

The multi-layered structure including an embedded ground layer 400 also includes a first non-conductive layer 135 disposed between the first conductive layer 150 and the second conductive layer 155 and a second non-conductive layer 137 disposed between the second conductive layer 155 and the conductive ground layer 160. The non-conductive layers depicted in FIG. 4 can be polyimide, polyester, FR4, polyethylene terephthalate (PET), PTFE (Teflon), and/or other compounds. An adhesive layer 140 is disposed between the second conductive layer 155 and the second non-conductive layer 137. A set of coverlay non-conductive layers 180 are disposed on the top and bottom portions of the multi-layered structure including an embedded ground layer 400. A set of coverlay adhesive layers 185 are disposed between the set of coverlay non-conductive layers 180 and the first conductive layer 150 and conductive ground layer 160, respectively. The set of coverlay non-conductive layers 180 and the set of coverlay adhesive layers 185 that encompass the plurality of layers therebetween can be referred to as a “non-conductive coating” for a FFC.

The first conductive layer 150, second conductive layer 155, and conductive ground layer 160 can be electrically coupled by a first via 165 and a second via 170. The first via 165 penetrates through the first non-conductive layer 135, thereby electrically connecting the first conductive layer 150 and second conductive layer 155. The second via 170 penetrates through the adhesive layer 140 and second non-conductive layer 137, thereby electrically connecting the second conductive layer 155 and the conductive ground layer 160. The formation of first via 165 and second via 170 can be completed using PCB manufacturing methods (e.g., via mechanical or laser drills).

The dimensions of each layer of the multi-layered structure including an embedded ground layer 400 depicted in FIG. 4 are not shown to scale. Reference will now be made to example dimensions that can be implemented within the multi-layered structure including an embedded ground layer 400. In embodiments, the height of each layer of the set of coverlay non-conductive layers 180 can be approximately 5-20 micrometers (μm). The height of each layer of the set of coverlay adhesive layers 185 can be approximately 5-50 μm. In embodiments, the bottom layer of the set of coverlay adhesive layers 185 (e.g., the coverlay adhesive layer in direct contact with the conductive ground layer 160) can have a height of approximately 25-50 μm. In embodiments, the top layer of the set of coverlay adhesive layers 185 (e.g., the coverlay adhesive layer in direct contact with the first conductive layer 150) can have a height of approximately 5-20 μm. The height of the first conductive layer 150 and second conductive layer 155 can be approximately 5-20 μm. The height of the first non-conductive layer 135 can be approximately 5-20 μm. The height of the second non-conductive layer 137 can be approximately 10-40 μm. The height of the adhesive layer 140 can be approximately 5-20 μm. The height of the conductive ground layer 160 can be approximately 25-50 μm. Overall, the height of the multi-layered structure including an embedded ground layer 400 can be approximately 140-220 μm, depending on the height of each respective layer.

The multi-layered structure including an embedded ground layer 400 improves upon existing FFC designs. By incorporating non-conductive layers between conductive layers, crosstalk and/or EMI between conductive layers can be reduced. For example, polyimide (or other dielectric/insulative materials) can absorb and dissipate signals between neighboring traces and/or conductive layers efficiently, thereby improving electrical performance. Further still, the inclusion of conductive ground layer 160 acts as an EMI shield to improve overall efficiency of the FFC design. The conductive ground layer 160 can be positioned outside the electrical signal traces of the conductive layers having traces (e.g., the first and second conductive layers 150 and 155) to block electromagnetic fields produced during operation. By grounding (e.g., electrically coupling) the first and second conductive layers 150 and 155 to the conductive ground layer 160, all conductive layers are electrically grounded to one another and therefore multiple paths are provided for charge to be dissipated, thereby reducing EMI. This can allow FFC designs that incorporate conductive layers with narrower traces, a larger amount of traces, and/or narrower spaces between traces while maintaining acceptable EMI and crosstalk.

In embodiments, additional conductive ground layers can be implemented. For example, a second conductive ground layer (not shown) can be implemented indirectly above the first conductive layer 150 (with an intervening non-conductive layer) and below the top coverlay adhesive and polyamide layers 180 and 185. This design can further reduce EMI, by further dissipating charge. Additional conductive ground layers can have the same dimensions as conductive ground layer 150 (e.g., 25-50 μm).

The multi-layered structure including an embedded ground layer 400 can be formed by generating each conductive layer having traces (e.g., the first conductive layer 150 and second conductive layer 155) according to FIGS. 1-3. Thereafter, the first conductive layer 150, second conductive layer 155, and conductive ground layer 160 can be stacked with the corresponding intervening layers depicted in FIG. 4 and subjected to heat and pressure (e.g., via a vacuum press or autoclave), thereby bonding the layers within the multi-layered structure including an embedded ground layer 400. Vias 165 and 170 can then be formed between the bonded layers, thereby electrically connecting each conductive layer. Lastly, the set of coverlay non-conductive layers 180 and the set of coverlay non-conductive adhesive layers 185 can be positioned and bonded as outside layers (e.g., uppermost and bottommost layers) via heat and pressure (e.g., via a vacuum press or autoclave), to insulate the layers therebetween from electrical disturbances, physical disturbances, and contamination.

Referring now to FIG. 5, shown is a multi-layered structure including an embedded ground layer and a conductive adhesive layer 500, in accordance with embodiments of the present disclosure. The multi-layered structure including an embedded ground layer and a conductive adhesive layer 500 is structurally and dimensionally similar to the multi-layered structure including an embedded ground layer 400. However, the multi-layered structure including an embedded ground layer and a conductive adhesive layer 500 includes a conductive adhesive layer 175 positioned below the second non-conductive layer 137 and above the conductive ground layer 160.

The conductive adhesive layer 175 electrically connects the second conductive layer 155 and the conductive ground layer 160. That is, a portion of the conductive adhesive layer 175 penetrates through the second non-conductive layer 137 and the adhesive layer 140, thereby electrically connecting the second conductive layer 155 and conductive ground layer 160. The conductive adhesive layer 175 enables charges within the first and second conductive layers 150 and 155 to be dissipated to conductive ground layer 160, thereby reducing EMI. In embodiments, a hole is left open within the second non-conductive layer 137 and the adhesive layer 140 during fabrication which is then filled with the conductive adhesive layer 175 prior to bonding the layers together. In embodiments, a hole can be made the second non-conductive layer 137 and the adhesive layer 140, via laser drilling, and filled with the conductive adhesive after bonding the layers together. In embodiments, the conductive adhesive layer 175 can have a height of approximately 25-55 μm. The resulting multi-layered structure including an embedded ground layer and a conductive adhesive layer 500 can have a height of approximately 180-260 μm. In embodiments, the conductive adhesive layer 175 can be an isotropic or anisotropic conductive material.

Utilizing conductive adhesive layer 175 to electrically connect the first conductive layer 150, second conductive layer 155, and conductive ground layer 160 is advantageous in embodiments where the FFC design is unable to accommodate a via (e.g., due to the via width being larger than trace width). Thus, conductive adhesive layer 175 can be used to tie ground traces together in situations where a via may be unable to.

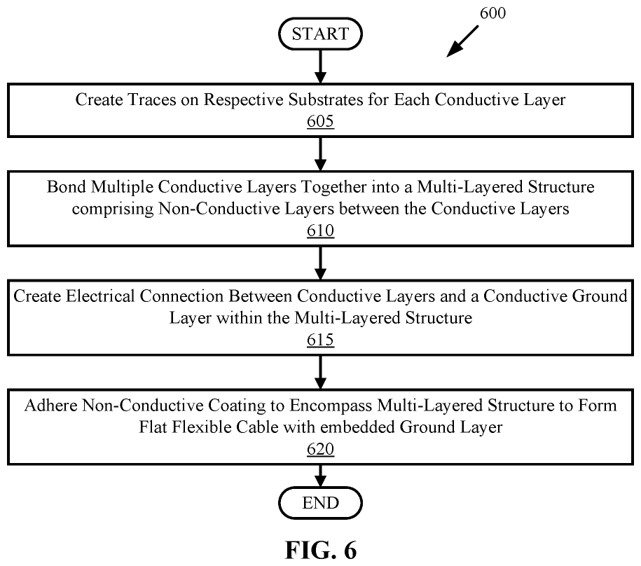

Referring now to FIG. 6, shown is a flowchart of an example method 600 for generating a flat flexible cable comprising a multi-layered structure having an embedded ground layer, in accordance with embodiments of the present disclosure.

Method 600 initiates at operation 605, where traces are formed on respective flexible substrates for each conductive layer to be included in the flat flexible cable. Forming traces on conductive layers can be completed in the same, or a substantially similar manner, as described with respect to FIGS. 1-2. Multiple conductive layers are then adhered together to create a multi-layered structure comprising non-conductive layers between the conductive layers. This is illustrated at operation 610. In embodiments, the non-conductive layers can be applied to the conductive layers prior to adhering the layers together, as shown in FIG. 3. However, in embodiments, non-conductive layers can be positioned and thereafter adhered when generating the multi-layered structure. That is, the operation of insulating the traces of conductive layers can occur when bonding the layers together rather than forming individual insulated conductive layers and thereafter bonding them together. Forming the multi-layered structure can include subjecting the positioned coplanar layers to heat and pressure, via a vacuum press or autoclave.

An electrical connection is then created between the conductive layers having traces (e.g., the first and second conductive layers 150, 155) and at least one conductive ground layer (e.g., conductive ground layer 160). This can be completed by drilling vias that penetrate through each respective conductive layer, thereby completing a path for charge to flow. This is illustrated in operation 615. In embodiments, one or more adhesive conductive layers can be implemented which can further function to ground the conductive layers and conductive ground layer, such as conductive adhesive layer 175 of FIG. 5. A non-conductive coating is then adhered to encompass the layers of the multi-layered structure to form an FFC with an embedded ground layer. This is illustrated in operation 620. In embodiments, the non-conductive coating can include the set of coverlay non-conductive layers 180 and the set of coverlay adhesive layers 185. The non-conductive coating can be adhered/applied by positioning materials of the non-conductive coating and subjecting the multiple layers to heat and pressure, for example, via a vacuum seal or autoclave.

The aforementioned operations can be completed in any order and are not limited to those described. Additionally, some, all, or none of the aforementioned operations can be completed, while still remaining within the spirit and scope of the present disclosure.

The above-referenced flat flexible cable designs comprising a multi-layered structure having an embedded ground layer can be integrated into a variety of electronic devices, including laptops, mobile phones, cameras, storage devices, computers, and servers. In embodiments, the above-referenced flat flexible cable designs comprising a multi-layered structure having an embedded ground layer can be integrated into tape systems. For example, the flat flexible cable designs comprising a multi-layered structure having an embedded ground layer can be integrated into the tape head module and card electronics of a tape system. It is noted that a FFC is a type of cable that is substantially flat (e.g., having a thickness or height of less than 1 mm, a width of 5-50 mm, and a variable length which can be 25 cm or greater) compared to other types of cables, such as round cables.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

What is claimed is:

1. A flat flexible cable comprising:
a first conductive layer with a plurality of traces;
a second conductive layer with a second plurality of traces;
a first non-conductive layer disposed between the first conductive layer and the second conductive layer; and
a second non-conductive layer disposed between the second conductive layer and a conductive ground layer, wherein the first conductive layer, the second conductive layer, and the conductive ground layer are electrically connected.

2. The flat flexible cable of claim 1, wherein the first and second conductive layers are copper.

3. The flat flexible cable of claim 1, wherein the first and second conductive layers have a height of approximately 5-20 μm.

4. The flat flexible cable of claim 1, wherein the first non-conductive layer is polyimide.

5. The flat flexible cable of claim 1, wherein the first non-conductive layer has a height of approximately 5-20 μm.

6. The flat flexible cable of claim 1, wherein the conductive ground layer has a height of approximately 25-50 μm.

7. A method for forming a flat flexible cable comprising:
bonding a first conductive layer having plurality of traces, a second conductive layer having a second plurality of traces, a first non-conductive layer, a second non-conductive layer, and a conductive ground layer together, wherein the first non-conductive layer is disposed between the first conductive layer and the second conductive layer and the second non-conductive layer is disposed between the second conductive layer and the conductive ground layer; and
creating an electrical connection between the first conductive layer, the second conductive layer, and the conductive ground layer.

8. The method of claim 7, wherein the first and second conductive layers are copper.

9. The method of claim 7, wherein the first and second conductive layers have a height of approximately 5-20 μm.

10. The method of claim 7, wherein the first non-conductive layer is polyimide.

11. The method of claim 7, wherein the first non-conductive layer has a height of approximately 5-20 μm.

12. The method of claim 7, wherein the conductive ground layer has a height of approximately 25-50 μm.

13. A flat flexible cable comprising:
a first conductive layer with a plurality of traces;
a second conductive layer with a second plurality of traces;
a first non-conductive layer disposed between the first conductive layer and the second conductive layer; and
a conductive adhesive layer disposed between a second non-conductive layer and a conductive ground layer, wherein the second non-conductive layer is disposed between the second conductive layer and the conductive adhesive layer, wherein the first conductive layer, the second conductive layer, the conductive adhesive layer, and the conductive ground layer are electrically connected.

14. The flat flexible cable of claim 13, wherein the first and second conductive layers are copper.

15. The flat flexible cable of claim 13, wherein the first and second conductive layers have a height of approximately 5-20 μm.

16. The flat flexible cable of claim 13, wherein the first non-conductive layer is polyimide.

17. The flat flexible cable of claim 13, wherein the first non-conductive layer has a height of approximately 5-20 μm.

18. The flat flexible cable of claim 13, where in the conductive ground layer has a height of approximately 25-50 μm.

19. The flat flexible cable of claim 13, wherein the conductive adhesive layer has a height of approximately 25-55 μm.

20. The flat flexible cable of claim 13, wherein a second conductive ground layer is disposed above and is electrically connected to the first conductive layer, the second conductive ground layer being copper and having a height of approximately 25-50 μm.
